(19) United States
(12) Patent Application Publication
(10) Pub. No.: US 2005/0180370 A1
(43) Pub. Date: Aug. 18, 2005

(54) Communication system, message conversion processor and method for processing a mobile radio message exchanged between a mobile radio terminal of a mobile radio communication network and a message conversion processor

(75) Inventors: Frank-Uwe Andersen, Berlin (DE); Michael Finkenzeller, Munchen (DE); Jochen Grimminger, Munchen (DE)

Correspondence Address: MORRISON & FOERSTER LLP, 1650 TYSONS BOULEVARD, SUITE 300, MCLEAN, VA, 22102, US

(73) Assignee: Siemens Aktiengesellschaft, Munchen (DE)

(21) Appl. No.: 11/038,466

(22) Filed: Jan. 21, 2005

(30) Foreign Application Priority Data
Jan. 23, 2004 (DE) 10 2004 003 550.4

(51) Int. Cl. H04Q 7/24

(52) U.S. Cl. 370/338

(57) ABSTRACT

A communication system and a method for processing a mobile radio message exchanged between a mobile radio terminal in a mobile radio communication network and a message conversion processor are proposed with a switching network having at least one processor and linked to a fixed network communication network and a mobile radio communication network, having a device, which is configured to use a mobile radio message to create a peer-to-peer message according to a peer-to-peer-communication protocol, so that said message can be transmitted to a processor in the fixed network communication network and/or to use a peer-to-peer message requested by a mobile radio terminal to create a mobile radio message according to a mobile radio communication protocol, so that the mobile radio message can be transmitted to the mobile radio terminal.

### CLAIM FOR PRIORITY

This application claims the benefit of priority to German Application No. 10 2004 003 550.4 which was filed in the German language on Jan. 23, 2004, the contents of which are hereby incorporated by reference.

### TECHNICAL FIELD OF THE INVENTION

The invention relates to a communication system, a message conversion processor and a method for processing a mobile radio message exchanged between a mobile radio terminal of a mobile radio communication network and a message conversion processor.

### BACKGROUND OF THE INVENTION

It is known that peer-to-peer services can be supplied by processors linked together by means of a fixed network communication network. Communication in the fixed network generally takes place according to the Internet Protocol (IP) and the Transport Control Protocol (TCP)/User Datagram Protocol (UDP) and according to the peer-to-peer protocol assigned to the respectively used peer-to-peer service.

Current mobile radio terminals are not suitable for direct use in known peer-to-peer networks for a number of reasons. Mobile radio communication connections in mobile radio communication networks set up according to the GSM standard or another third generation mobile radio standard, e.g. GPRS, have very low bit rates.

Also, the storage space available in current mobile radio terminals is very restricted and it is not foreseeable, even in the future, that mobile radio terminals will be able to provide a storage capacity of several gigabytes, as is for example available with current standard personal computers. The use of a mobile radio terminal in a peer-to-peer network incurs uneconomically high costs for the user of the mobile radio terminal, as the search algorithms to detect the required electronic peer-to-peer files would take up all the capacity of a standard mobile radio terminal.

The requested content can also frequently not be used or executed on the mobile radio terminal itself, particularly due to user interface limitations such as the absence of a screen for video, inadequate graphics capability, absence of or inadequate speakers, etc.

It is not yet possible at present to use mobile radio terminals for peer-to-peer services for technical reasons. This is due on the one hand to the so-called bootstrapping mechanism for peer-to-peer services and the absence of multicast support as well as the fact that passive availability is often not possible for management purposes for IP data packets, resulting in an absence of server function for mobile radio terminals.

The MMS (Multimedia Message Service), specified in “WAP-205-MMSArchOverview-20010425-a”, is however known to allow the exchange of multimedia data between individual mobile radio terminals and also to allow such multimedia data to be sent from a mobile radio terminal to an e-mail recipient in a fixed network communication network and vice versa. To send multimedia data from a user, i.e. processor, on the Internet to a mobile radio terminal with MMS functionality, there are special web portals, which are provided by the operator of the mobile radio communication network and which allow the composition of an MMS message.

An interface for the exchange of data between a mobile radio terminal and users on the Internet, i.e. a processor in the fixed network communication network, is specified for this purpose. The MMS architecture comprises a so-called MMS client, which is connected via the MMSM interface to a processor referred to as an MMS proxy relay in the mobile radio communication network. If the destination address is an E.164-compliant address, this processor forwards data to a further processor (MMS server) via the MMSs interface. If an e-mail address is input as the destination address by the user of the mobile radio terminal, the data is forwarded from the MMS proxy relay via an interface referred to in the specification as “E” to any processor in the fixed network communication network (Internet) serving as an e-mail server.

It is currently only possible to send data, in particular multimedia files, from a mobile radio terminal to a processor in the fixed network communication network by means of e-mail. A data exchange between a processor in the fixed network communication network and a mobile radio terminal is not provided for.

### SUMMARY OF THE INVENTION

The present invention allows mobile radio terminals to be used in a peer-to-peer network in a low-cost and economically viable manner.

In one embodiment of the invention, there is a communication system having a mobile radio communication network with at least one mobile radio terminal, a fixed network communication network with at least one processor and a switching network having at least one processor. This switching network is linked to the fixed network communication network and the mobile radio communication network. It has a device, which is configured to use a mobile radio message to create a peer-to-peer message according to a peer-to-peer communication protocol, so that it can be transmitted to a processor in the fixed network communication network and/or to use a peer-to-peer message requested by a mobile radio terminal to create a mobile radio message according to a mobile radio communication protocol, so that the mobile radio message can be transmitted to the mobile radio terminal.

The message conversion processor according to one embodiment of the invention is set up such that it can use a mobile radio message to create a peer-to-peer message according to a peer-to-peer communication protocol, so that it can be transmitted to a processor in the fixed network communication network and/or to use a peer-to-peer message requested by a mobile radio terminal to create a mobile radio message according to a mobile radio communication protocol, so that the mobile radio message can be transmitted to the mobile radio terminal.

The mobile radio message is preferably an MMS according to 3G-TS 22.140. The invention is thus evident from the fact that the message conversion processor converts an MMS sent to an e-mail recipient and available to a peer-to-peer service, so that the content of the MMS can be found. The interface “E” referred to above is thereby used for the transmission of data from an MMS-capable mobile radio terminal to one of the peer-to-peer services. The mobile radio terminal sends the message to the e-mail address of a peer-to-peer proxy processors of a peer-to-peer service, which is able to convert the mobile radio message present as an MMS and integrate the peer-to-peer functionality. Alternatively the mobile radio message can also be received by the message conversion processor by http-upload according to the so-called “post” method.

With one embodiment of the method according to the invention for processing a mobile radio message sent from a mobile radio terminal of a mobile radio communication network to a message conversion processor, a mobile radio message is used to create a peer-to-peer message according to a peer-to-peer communication protocol and this peer-to-peer message is transmitted to a processor in the fixed network communication network.

With another method for processing a peer-to-peer message sent from a processor in a fixed network communication network to a message conversion processor, a peer-to-peer message requested by a mobile radio terminal is used to create a mobile radio message according to a mobile radio communication protocol and the mobile radio message is transmitted to the mobile radio terminal.

According to an advantageous embodiment, the device is configured to detect a request message on the part of a mobile radio terminal, in which one or more peer-to-peer messages is/are requested, and to request this from one of the processors in the fixed network communication network and to buffer it. It is hereby assumed that a mobile radio terminal has sent a search request to a peer-to-peer service via a peer-to-peer proxy processor in the network of the mobile radio network operator. The recipient of this search request should be the mobile radio terminal itself. In addition to the standard functional scope of a peer-to-peer proxy processor, the device also includes the following:

A module that is specific to the peer-to-peer service allows responses of a specific peer-to-peer service to be interpreted and the data found or requested to be downloaded and stored locally. With known procedures, the downloading and use of the data found would generally take place later via the fixed network. With this procedure, the search request is made via the mobile radio terminal and notification of the successful search. With the invention it is now possible actually to make the data provided by the peer-to-peer service available on the mobile radio terminal. The data can be further processed using user-specific settings, e.g. profiles such as the user agent profile (UAProf, described in WAP-Forum WAG), to allow the user of the mobile radio terminal to use the data or to allow a preview. The device verifies whether the requested data can be displayed on the user's mobile radio terminal and converts said data if necessary. For example a large image could be converted to a smaller image that can be displayed.

The device is therefore preferably arranged in a buffer processor in the switching network, which is linked to the fixed network communication network. This buffer processor is preferably a peer-to-peer proxy processor.

In a further embodiment the buffer processor is linked to a first interface processor, which receives a mobile radio message sent to an e-mail recipient from a mobile radio terminal and sends it to the buffer processor. The first interface processor preferably represents the above-mentioned MMS proxy relay processor, which is set up by the operator of the mobile radio communication network.

The buffer processor is expediently linked to a second interface processor, which sends the mobile radio message or information about the destination address of the requested mobile radio message to the requesting mobile radio terminal. The second interface processor is preferably configured as an MMS server, as already known from the prior art.

The device carrying out the data conversion is preferably configured such that it can separate the file attachments of the mobile radio message from the message itself.

It is preferably configured such that it can generate peer-to-peer contexts with an object and description from the mobile radio message.

It is also preferable for the device to be configured such that it can assign the mobile radio message to a specific peer-to-peer system.

It is also preferable for the device to be configured such that, when converting the peer-to-peer message to the mobile radio message, it takes into account the input/output capabilities of the mobile radio terminal requesting the message. According to a further embodiment, before sending the mobile radio message, the device detects whether the context of the peer-to-peer message should also be transmitted to the mobile radio terminal.

The invention resolves the problem of allowing the exchange of content or data between a mobile radio message, preferably an MMS, and a peer-to-peer service in the described manner. The invention thereby utilizes a peer-to-peer proxy processor, which is able, as proxy, to instantiate peer-to-peer sessions for any mobile radio terminals, including local data storage and control of the session via mobile radio messages such as SMS or WAP or even http. To date the peer-to-peer session has been controlled using such a processor via the air interface but solely between processors in the fixed network communication network, as data requested by a mobile radio terminal was retrieved at a later time via another processor in the fixed network communication network. The invention uses this processor to convert mobile radio messages to peer-to-peer messages according to a peer-to-peer communication protocol and vice versa, by extending the functionality of this processor.

The device according to the invention allows identification of the data transmitted from a mobile radio terminal within the mobile radio message. This information, separated from the mobile radio message, is transferred to a user-independent peer-to-peer session and made available to the peer-to-peer network. The content of the mobile radio message is hereby integrated into existing peer-to-peer systems and can therefore be located in a lexical manner. Modifications to the mobile radio terminal or nature of data transmission compared with known procedures are not required.

The functionality of a peer-to-peer proxy processor is also used in the context of the transmission of a peer-to-peer message to a mobile radio telephone. It is thereby assumed that a search request has already been activated from a mobile radio terminal to a peer-to-peer service. The device according to the invention makes it possible to interpret the response of the peer-to-peer service, so that the mobile radio terminal can retrieve the data found. Alternatively, the data found can be stored locally in the peer-to-peer proxy processor, the mobile radio terminal receiving a message about the local data storage point, so that it can in turn prompt retrieval of the data. To allow use in the mobile radio terminal, the device verifies whether the requested data can be stored and displayed there. The device carries out a conversion if necessary.

### BRIEF DESCRIPTION OF THE DRAWINGS

An exemplary embodiment of the invention is shown in the Figure and described in more detail below.

FIG. 1 shows a communication system according to the invention.

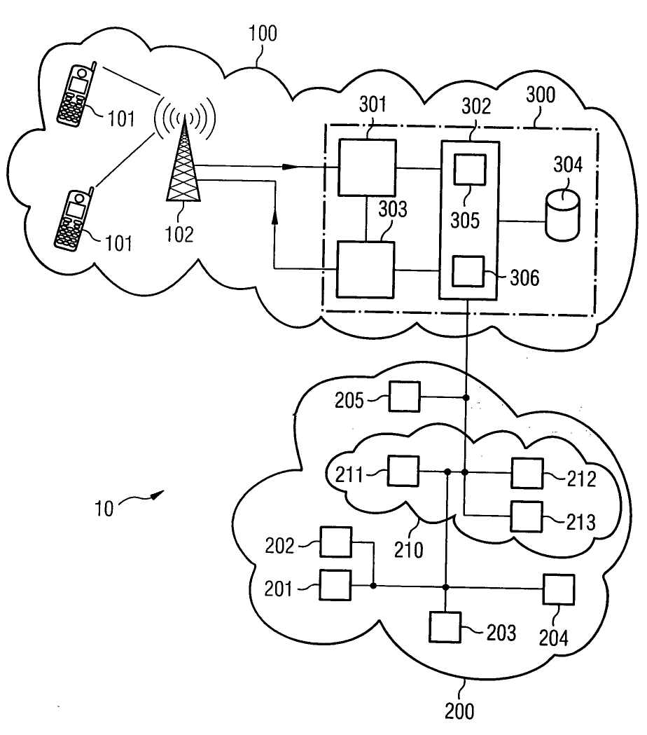

### DETAILED DESCRIPTION OF THE INVENTION

The invention shows a communication system 10 according to the invention with a mobile radio communication network 100 and a fixed network communication network 200. The communication network 10 in particular allows MMS-capable mobile radio terminals to make locally generated videos, photos, sound or text files for example available to a peer-to-peer service and to allow this content to be located within the peer-to-peer network, e.g. by name. The communication system 10 also allows request messages (search requests) from a mobile radio terminal, which is in particular MMS-capable, to be processed and the files correspondingly requested to be made available to the mobile radio terminal in such a manner that they can be read there.

A plurality of processors 201, 202, 203, 204, 205, 211, 212, 213 is provided in the fixed network communication network 200, which are linked together and use the Internet Protocol (IP) and the Transport Control Protocol (TCP) for communication. The fixed network communication network 200 is therefore based on Internet protocols.

Peer-to-peer services are also installed in a freely predefinable manner in the fixed network processors 211, 212, 213, at least some of these also being able to supply and use peer-to-peer services. In principle any peer-to-peer services and peer-to-peer-communication protocols are thereby possible.

The fixed network processors 211, 212, 213 form a so-called generic peer-to-peer-network. This is a virtual network of processors, which can communicate with each other according to the respective peer-to-peer service or the respective peer-to-peer communication protocol.

A plurality of mobile radio terminals 101 is provided in the mobile radio communication network 100, set up to supply or use peer-to-peer services. The mobile radio terminals 101 are linked via a radio connection to a base station 102. The SGSN processor and GGSN processor required for example with the UMTS standard are not shown in the Figure for the sake of clarity.

The mobile radio communication network 100 also has a switching network 300. This has a first interface processor 301, which is connected to a buffer processor 302 and a second interface processor 303. This is also connected to the buffer processor. The switching network 300 is also linked to the fixed network communication network 200. The buffer processor 302 is also connected to a storage unit 304, which can be of any type.

The first interface processor 301 is set up to receive a mobile radio message from a mobile radio terminal 101. If the message is an MMS, which is addressed to another mobile radio terminal 101, it forwards this to the second interface processor 303, which finally forwards the mobile radio message via the base station 102 to the corresponding mobile radio terminal 101. In the present exemplary embodiment the first interface processor 301 represents a so-called MMS proxy relay. The second interface processor 303 has the functionality of an MMS server known in principle from the prior art.

If the mobile radio message from a mobile radio terminal 101 is however addressed to an e-mail recipient, thus to a processor in the fixed network communication network 200, the first interface processor 301 transmits the mobile radio message to the buffer processor 302. As mentioned above, the basic concept behind the invention is that the mobile radio message contains multimedia data, which is to be made available by the mobile radio terminal 101 to a peer-to-peer service. According to the invention, the buffer processor 302 having the function of a peer-to-peer proxy has a device 305 for this purpose, which identifies the sender address of the user, i.e. the sending mobile radio terminal 101, and separates it if necessary. The sender address of the user could have the format User-Telephonenumber@(Operatorname.Networkname). The device 305 is also able to identify the peer-to-peer communication system requested by the mobile radio terminal 101, for example from the “Re” line of the mobile radio message and to forward the message to the corresponding service in the fixed network communication network 200. The device 305 is also able to identify metadata (text describing content, images, sound, video). It is also possible to convert mobile radio message content here. The unpacking of compressed data is considered here in particular. User-specific extensions can also be identified, such as the name of the content, access rights and groups and the storage/residence time in the buffer processor 302, i.e. more precisely in the storage unit 304. After the above-mentioned content of the mobile radio message has been separated and identified, it can be transferred to a user-independent peer-to-peer session, i.e. made available to other users.

The device in the buffer processor 302 thus allows integration of the content of the MMS into a peer-to-peer system, as a result of which it can be located in a lexical manner. In particular no modifications to the mobile radio terminal or MMS system itself are required.

The buffer processor 302 has a further device 306, which allows a mobile radio terminal 101 to use a peer-to-peer service. Use is thereby preferably achieved by means of the widely distributed system of the MMS. Once a mobile radio terminal has sent a request message to a peer-to-peer service, with the mobile radio terminal itself specified as the recipient therein, the result(s) can be sent in MMS format to the mobile radio terminal. This service can be provided by the operator of the mobile radio communication network, as the buffer processor 302 and the device 306 contained therein are in said operator's access range. The messages present according to a peer-to-peer communication protocol are converted in the device 306 to the MMS format, which can be processed by a mobile radio terminal 101, and transmitted to the second interface processor 303, which can send these in the known manner via the base station 202 to the requesting mobile radio terminal 101.

Compared with the prior art, only the buffer processor 302 has to be modified by the device 306, which enables the buffer processor 302 (peer-to-peer proxy processor) to implement the following services:
The device 306 allows responses of a peer-to-peer service to be interpreted and allows the respective processor to download the data found from the fixed network communication network 200 and the data to be stored locally (in the storage unit 304). Unlike the usual procedure, whereby the user retrieves the data found later via the fixed network, the data can be processed further using user-specific settings (profiles), to allow the user of a mobile radio terminal to use the data on this or to have a type of “preview”.
It is verified in particular in the device 306 whether the data can be displayed on the user's mobile device and a conversion must be carried out if necessary. For example a large image is converted to a smaller image that can be displayed on the display unit of the mobile radio terminal.
The converted data is then forwarded to the second interface processor 303 according to the user profile. This processor sends an SMS or MMS message to the mobile radio terminal, informing the user about the provision of the data. Alternatively a so-called “push” message is transmitted directly to the mobile radio terminal, to indicate the presence of the message and prompt a download by the mobile radio terminal itself.

The invention allows the exchange of data between unmodified MMS-capable mobile radio terminals and any Internet-based peer-to-peer services. The combination of mobile radio message and messages according to a peer-to-peer-communication protocol can be achieved without infringing existing standards. Mobile radio messages here are MMS messages in particular, as these are suitable for the transmission of multimedia files. The invention could however in principle also operate with other types of mobile radio message.

To use or display information supplied by a peer-to-peer service, the user of a mobile radio terminal can choose either a preview or direct use of the content on the mobile radio terminal.

The invention allows the controlled provision of mobile radio messages in Internet-based peer-to-peer communication networks.

Existing technology is thereby used in an efficient manner, so there is no unnecessary load on the mobile network or air interfaces due to the high bit-rate traffic which is inherent in a peer-to-peer system.

1. A communication system, comprising:
a mobile radio communication network with at least one mobile radio terminal;
a fixed network communication network with at least one processor; and
a switching network having at least one processor which is linked to the fixed network communication network and the mobile radio communication network, with a device, which is configured to use a mobile radio message to create a peer-to-peer message according to a peer-to-peer-communication protocol, so that the message can be transmitted to a processor in the fixed network communication network and/or to use a peer-to-peer message requested by a mobile radio terminal to create a mobile radio message according to a mobile radio communication protocol, so that the mobile radio message can be transmitted to the mobile radio terminal.

2. The communication system according to claim 1, wherein the device is configured to detect a request message on part of a mobile radio terminal, in which one or more peer-to-peer messages is requested, to request it from one of the processors in the fixed network communication network and to buffer it.

3. The communication system according to claim 1, wherein
the device is arranged in a buffer processor in the switching network, which is linked to the fixed network communication network.

4. The communication system according to claim 1, wherein the buffer processor is a peer-to-peer proxy processor.

5. The communication system according to claim 1, wherein the buffer processor is linked to a first interface processor, which receives a mobile radio message addressed to an e-mail recipient from a mobile radio terminal and sends it to the buffer processor.

6. The communication system according to claim 1, wherein the buffer processor is linked to a second interface processor, which sends the mobile radio message or information about the destination address of the requested mobile radio message to the requesting mobile radio terminal.

7. The communication system according to claim 1, wherein the device is configured such that it can separate file attachments of the mobile radio message from the message itself.

8. The communication system according to claim 1, wherein the device is configured such that it can generate peer-to-peer contexts with an object and description from the mobile radio message.

9. The communication system according to claim 1, wherein the device is configured such that it can assign the mobile radio message to a specific peer-to-peer system.

10. The communication system according to claim 1, wherein the device is configured such that, during conversion of the peer-to-peer message to the mobile radio message, it takes into account the input/output capabilities of the mobile radio terminal requesting the message.

11. The communication system according to claim 1, wherein the device is configured such that, before sending the mobile radio message, it detects whether the context of the peer-to-peer message should also be transmitted.

12. A message conversion processor, configured to use a mobile radio message to create a peer-to-peer message according to a peer-to-peer-communication protocol, so that the message is transmitted to a processor in a fixed network communication network or uses a peer-to-peer message requested by a mobile radio terminal to create a mobile radio message according to a mobile radio communication protocol, so that the mobile radio message is transmitted to the mobile radio terminal.

13. A method for processing a mobile radio message sent from a mobile radio terminal of a mobile radio communication network to a message conversion processor, comprising:
providing a mobile radio message to create a peer-to-peer message according to a peer-to-peer-communication protocol; and
transmitting the peer-to-peer message to a processor in a fixed network communication network.

14. A method for processing a peer-to-peer message sent from a processor in a fixed network communication network to a message conversion processor, comprising:
providing a peer-to-peer message requested by a mobile radio terminal to create a mobile radio message according to a mobile radio communication protocol; and
transmitting the mobile radio message to the mobile radio terminal.
